(19) United States
(12) Patent Application Publication
(10) Pub. No.: US 2025/0083485 A1
(43) Pub. Date: Mar. 13, 2025

(54) AMPHIBIOUS VEHICLE AND STEERING SYSTEM

(71) Applicant: Ontario Drive & Gear Limited, New Hamburg (CA)

(72) Inventors: Justin Michael Kunz, Thief River Falls, MN (US); Micheal Schley, Holt, MN (US)

(73) Assignee: Ontario Drive & Gear Limited, New Hamburg (CA)

(21) Appl. No.: 18/829,224

(22) Filed: Sep. 9, 2024

Related U.S. Application Data
(60) Provisional application No. 63/537,533, filed on Sep. 10, 2023.

(51) Int. Cl. B60F 3/00; B62D 11/14

(52) U.S. Cl. CPC B60F 3/0007; B62D 11/14

(57) ABSTRACT

A skid-steered amphibious vehicle includes ground engaging members, an electric drive motor, and an electric steer motor. The electric drive motor and electric steer motor are drivingly coupled to a transmission for driving and steering the vehicle. The vehicle also has a zero turn selector and the zero turn selector has a first configuration and a second configuration. The vehicle includes at least three operation modes, including: a park mode, a forward mode, and a reverse mode. When the vehicle is in the forward mode and the zero turn selector is in the first configuration, the controller permits the vehicle to conduct a zero turn and when the vehicle is in the forward mode and the zero turn selector is in the second configuration, the controller does not permit the vehicle to conduct a zero turn.

### CROSS-REFERENCE TO RELATED APPLICATIONS

This application claims the benefit of U.S. Patent Application No. 63/537,533, filed Sep. 10, 2023, the entire content of which is hereby incorporated herein by reference.

### BACKGROUND

Various styles of amphibious vehicles have been utilized to operate with varying degrees of success on land and water. There remains a need, however, for amphibious vehicles having improved performance and quieter operation.

All U.S. patents and applications and all other published documents mentioned anywhere in this application are incorporated herein by reference in their entirety.

### SUMMARY

In some embodiments, a skid-steered vehicle includes a tub, a plurality of ground engaging members, an electric drive motor, an electric steer motor, a controller, and a transmission. The transmission has a first input and a second input. The first input is rotationally coupled to the electric drive motor and the second input is rotationally coupled to the electric steer motor. The vehicle also includes a zero turn selector and the zero turn selector has a first configuration and a second configuration. At least three operation modes are present on the vehicle: a park mode, a forward mode, and a reverse mode. When the vehicle is in the forward mode and the zero turn selector is in the first configuration, the controller permits the vehicle to conduct a zero turn and when the vehicle is in the forward mode and the zero turn selector is in the second configuration, the controller does not permit the vehicle to conduct a zero turn.

In some embodiments, when the vehicle is in the park mode or reverse mode, the controller does not permit the vehicle to conduct a zero turn.

In some embodiments, the vehicle has least six ground engaging members.

In some embodiments, one or both of the electric drive motor and electric steer motor are alternating current motors.

In some embodiments, when the vehicle is in the reverse mode and the electric drive motor is rotating at more than zero RPM, the steer motor control is inverted.

In some embodiments, when the vehicle is in reverse mode, the electric drive motor rotates in a direction opposite than when the vehicle is in forward mode.

In some embodiments, the vehicle further comprises a plurality of sprockets and chains.

In some embodiments, the vehicle further comprises a plurality of drive axles.

In some embodiments, at least one of the plurality of sprockets is rotationally coupled to at least one of the drive axles and at least one of the chains is drivingly coupled to at least one of sprockets.

In some embodiments, a skid-steered vehicle includes a tub, a plurality of ground engaging members, an electric drive motor, an electric steer motor, a controller, a transmission, steering controls, a steering angle sensor, and an IMU. The transmission has a first input and a second input. The first input is rotationally coupled to the electric drive motor and the second input is rotationally coupled to the electric steer motor. The controller determines if the IMU and steering angle sensor are in agreement that the vehicle is turning and, if the IMU and steering angle sensor are not in agreement, the controller turns off current to the electric steer motor.

In some embodiments, if the IMU and steering angle sensor are in agreement that the vehicle is not turning, the controller remains in standby.

In some embodiments, at least one of the electric drive motor and electric steer motor are coupled to the transmission via a belt.

In some embodiments, the electric drive motor is coupled to the transmission via a belt and the electric steer motor is coupled to the transmission via a belt.

### BRIEF DESCRIPTION OF THE DRAWINGS

FIG. 1 is a perspective view of the amphibious vehicle according to some embodiments.

FIG. 2 is a right side view of the amphibious vehicle according to some embodiments.

FIG. 3 is a left side view of the amphibious vehicle according to some embodiments.

FIG. 4 is a front view of the amphibious vehicle according to some embodiments.

FIG. 5 is a rear view of the amphibious vehicle according to some embodiments.

FIG. 6 is a top view of the amphibious vehicle according to some embodiments.

FIG. 7 is a perspective view of the amphibious vehicle according to some embodiments.

FIG. 7A is a detailed view of a portion of the amphibious vehicle of FIG. 7.

FIG. 8 is a perspective view of various drivetrain components and frame of the amphibious vehicle according to some embodiments.

FIG. 9 is a bottom view of various drivetrain components and frame of the amphibious vehicle according to some embodiments.

FIG. 10 is a right side view of various drivetrain components and frame of the amphibious vehicle according to some embodiments.

FIG. 11 is a front view of various drivetrain components and frame of the amphibious vehicle according to some embodiments.

FIG. 12 is a top view of various drivetrain components and frame of the amphibious vehicle according to some embodiments.

FIG. 13 is a perspective view showing various frame and drive train components, along with steering controls, according to some embodiments.

FIG. 14 is a perspective view showing the transmission, electric steer motor, and electric drive motor in an assembly, according to some embodiments.

FIG. 15 is a side view showing steer motor connected to the transmission via a belt, according to some embodiments.

FIG. 16. is a top view showing the transmission, electric steer motor, and electric drive motor in an assembly, according to some embodiments.

FIG. 17 is a mode flow diagram.

FIG. 18 is a steering angle/IMU flow diagram.

### DETAILED DESCRIPTION

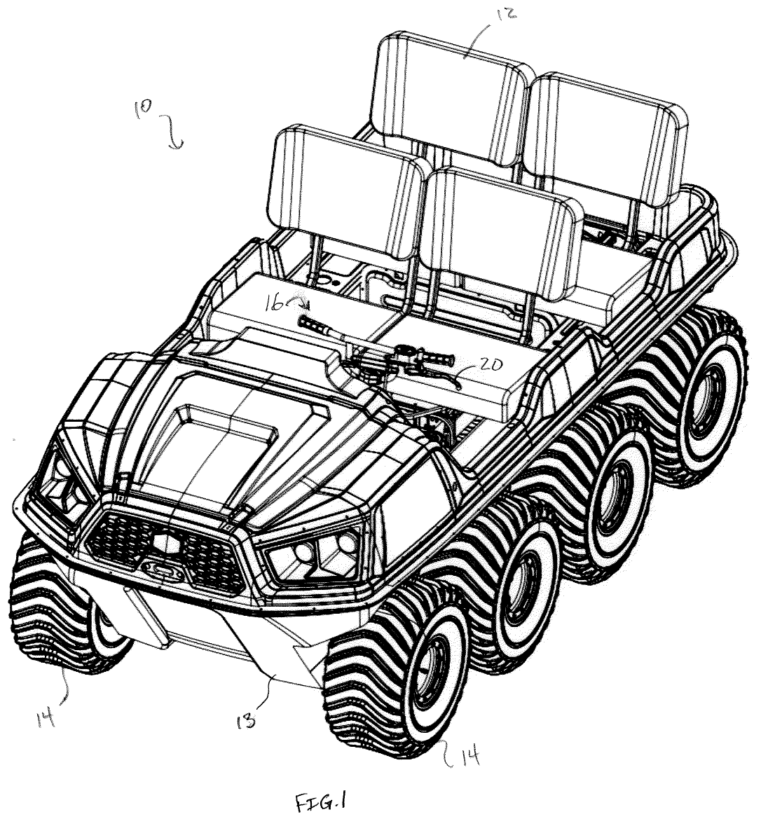

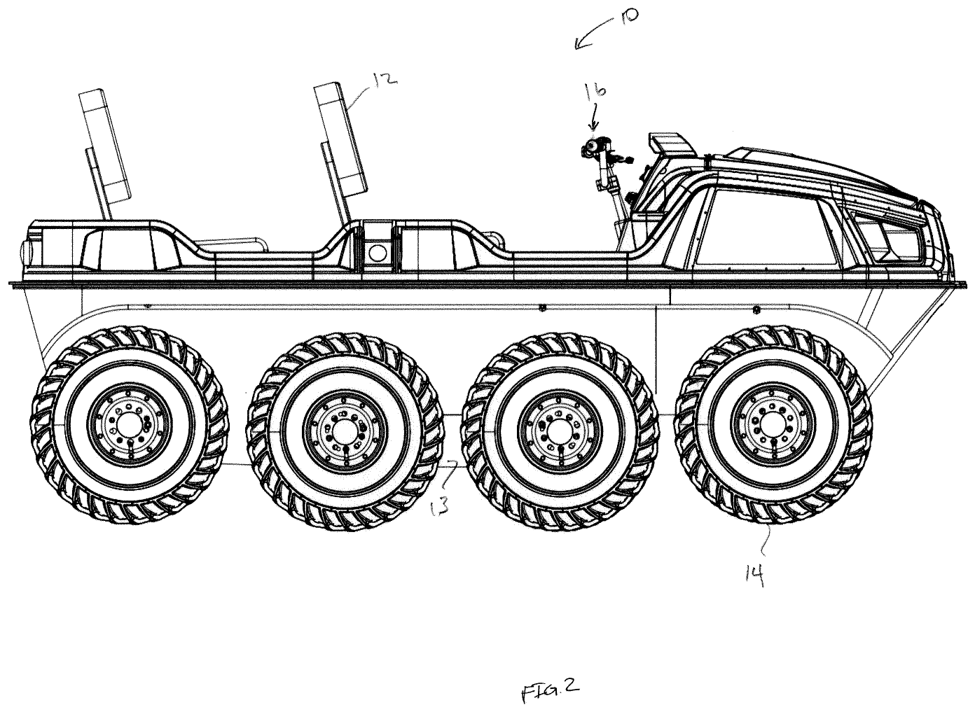

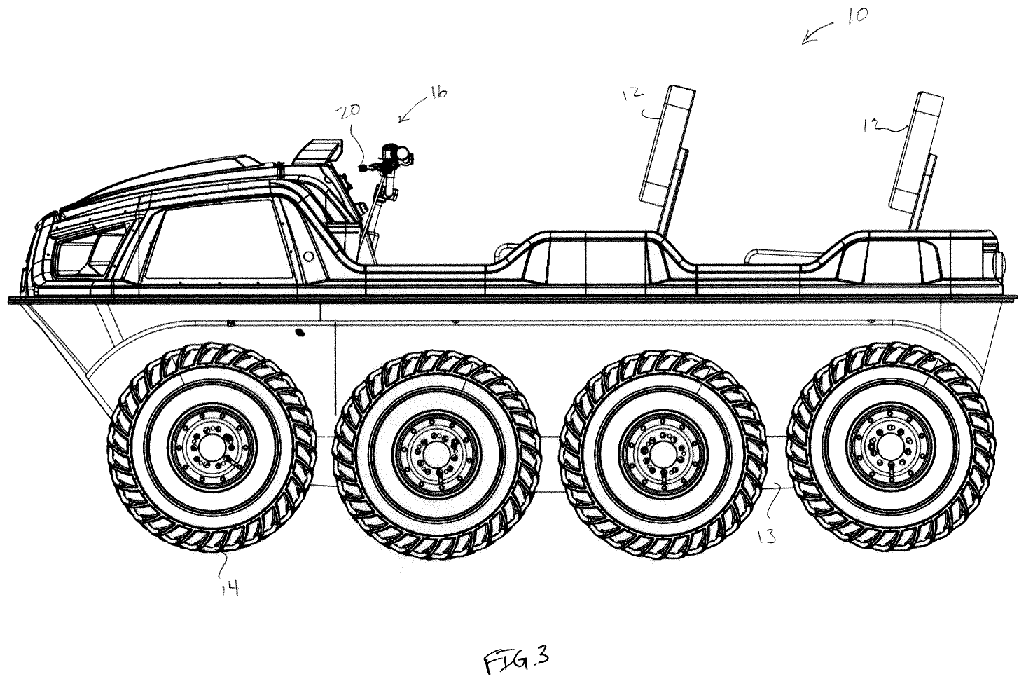

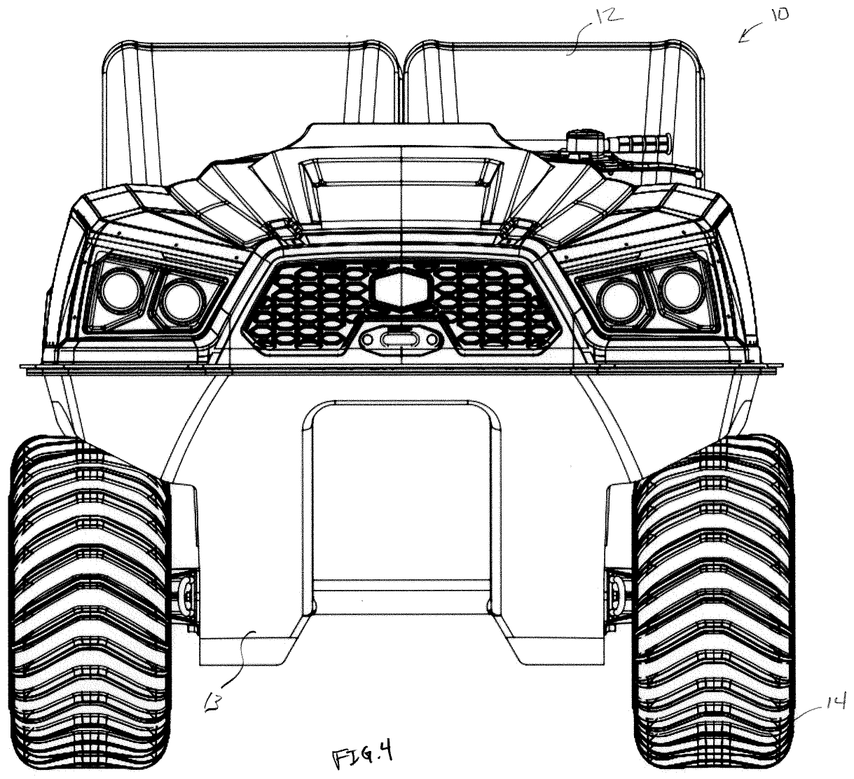

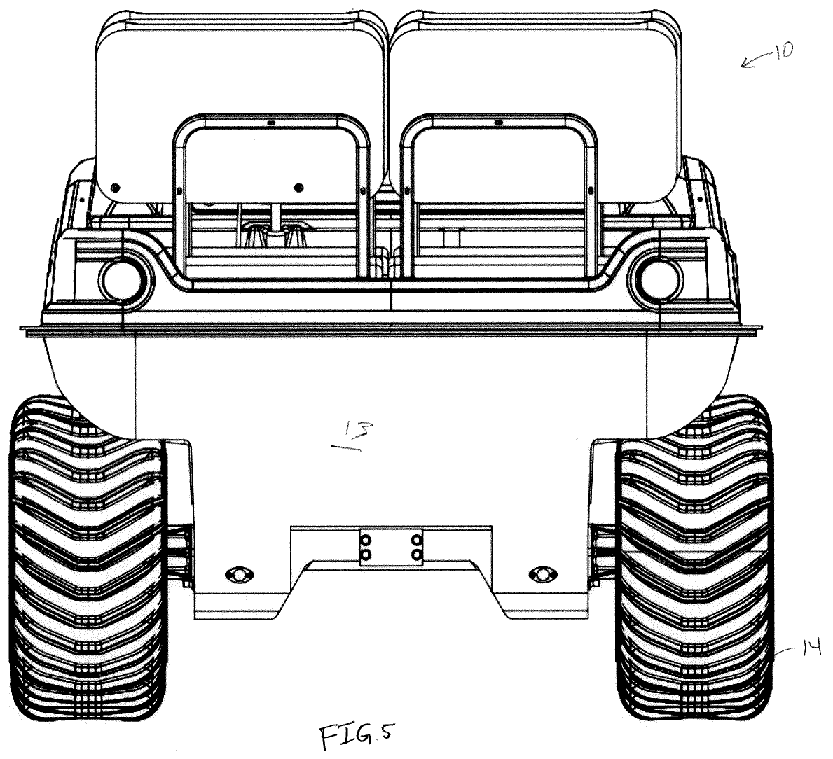

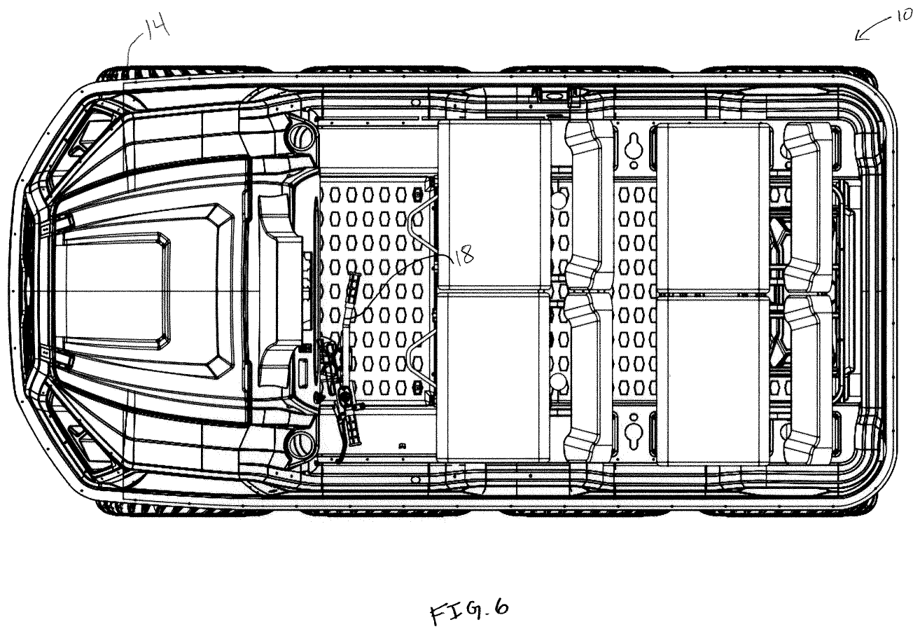

Referring to FIGS. 1-7, in some embodiments, a vehicle 10, for example an amphibious vehicle as shown, includes one or more seats 12, a plurality of ground engaging members 14 (e.g., tires, tracks, etc.), and operator controls 16. In some embodiments, the vehicle 10 further includes a tub 13 to provide buoyancy in the water, such that the vehicle 10 floats in the water. In some embodiments, the vehicle 10 is a skid-steered vehicle such that in order to turn the vehicle, the ground engaging members 14 rotate more quickly than those on the other side. The vehicle 10 can have any suitable number of ground engaging members 14, for example six total (three on each side) or eight total (four on each side) or two total (e.g., where one track is used on each side).

In some embodiments, the vehicle 10 is fully electric, for example utilizing one or more electric motor(s) to move the vehicle 10, and one or more batteries to power the electric motor(s).

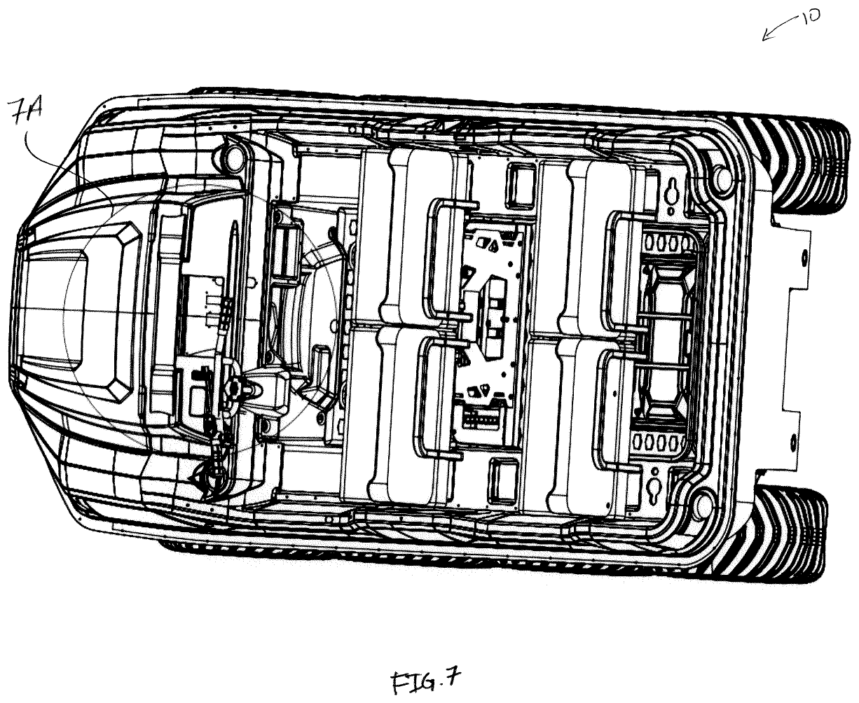

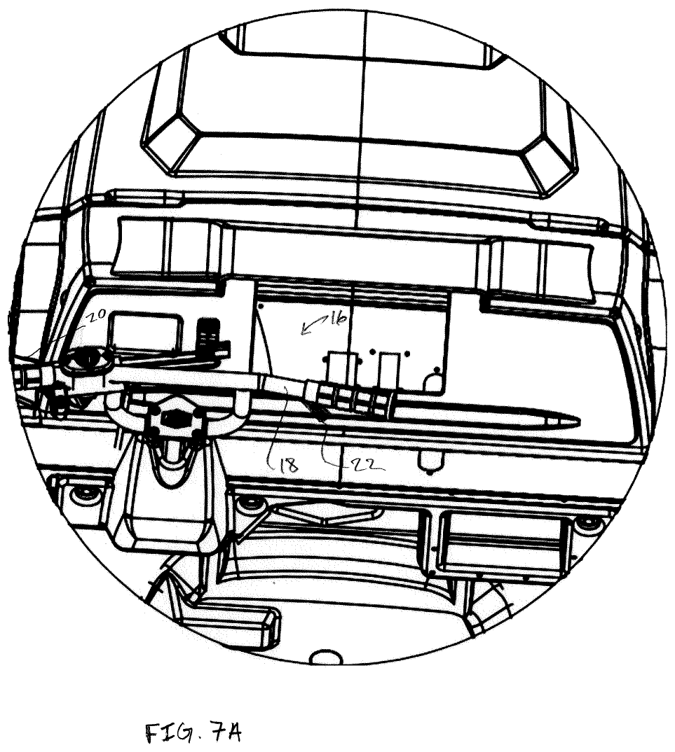

As shown in FIG. 7A, in some embodiments, the operator controls 16 include steering controls 18, brake controls 20, and an accelerator 22. In some embodiments, the steering controls 18 are handlebars, however a steering wheel or other suitable arrangement may be utilized. In some embodiments, the brake controls 20 include a handgrip lever, which is operatively connected to a master cylinder. Regenerative braking arrangement may also be utilized in lieu of or in addition to braking systems having fluid (e.g., master cylinder, caliper).

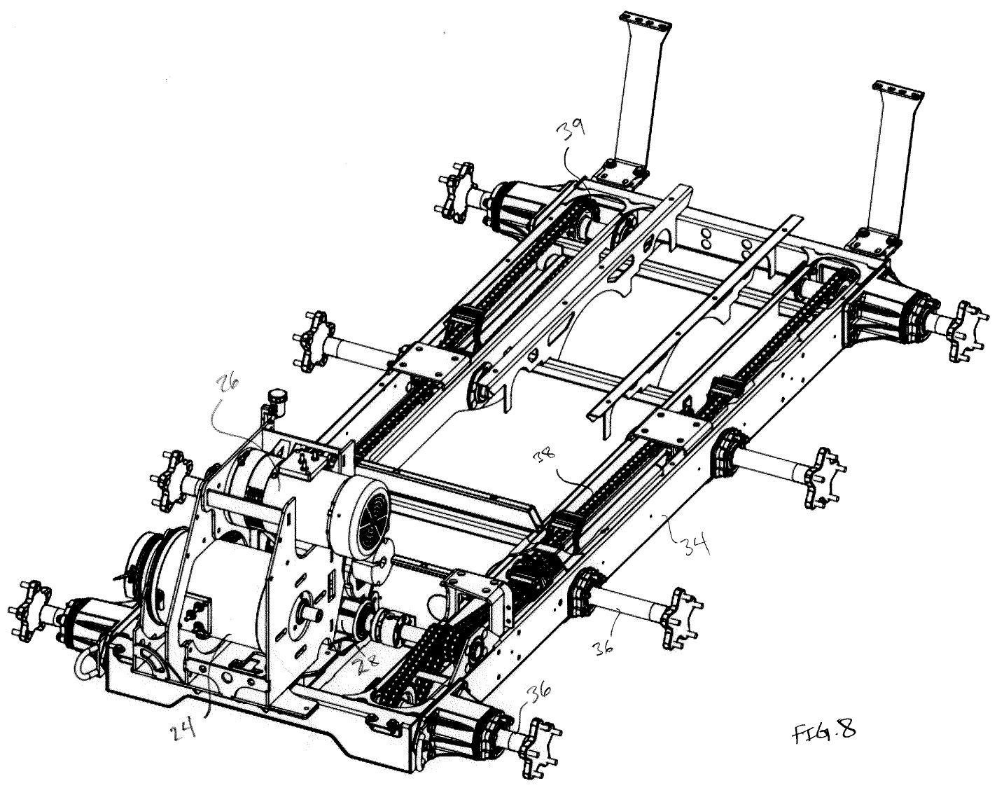

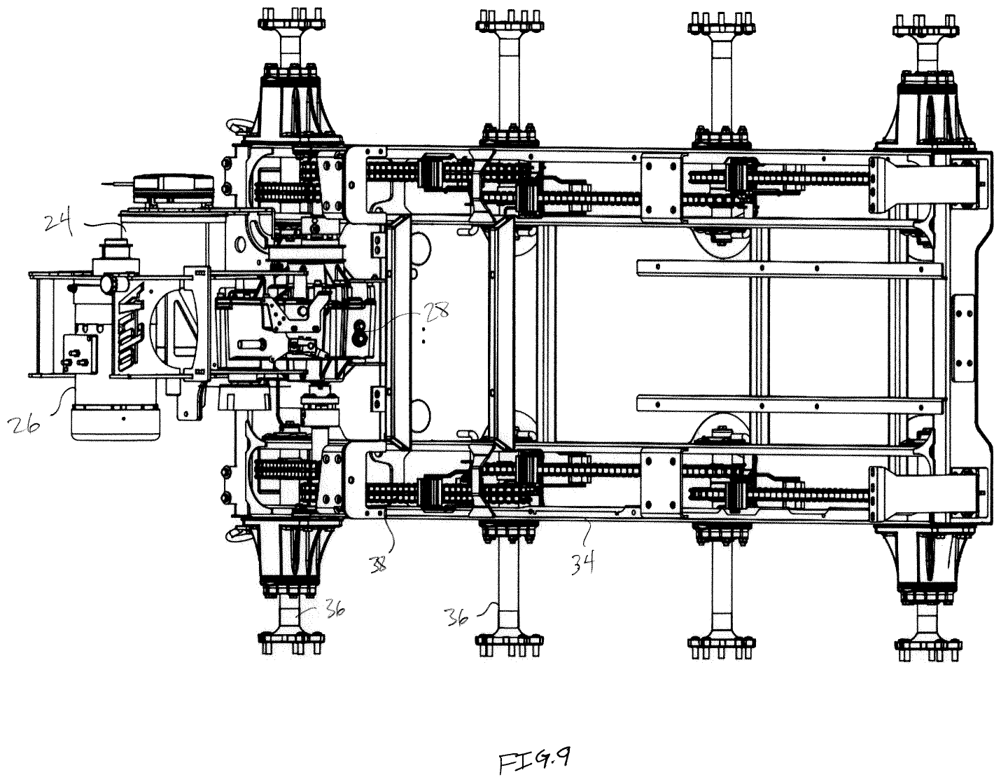

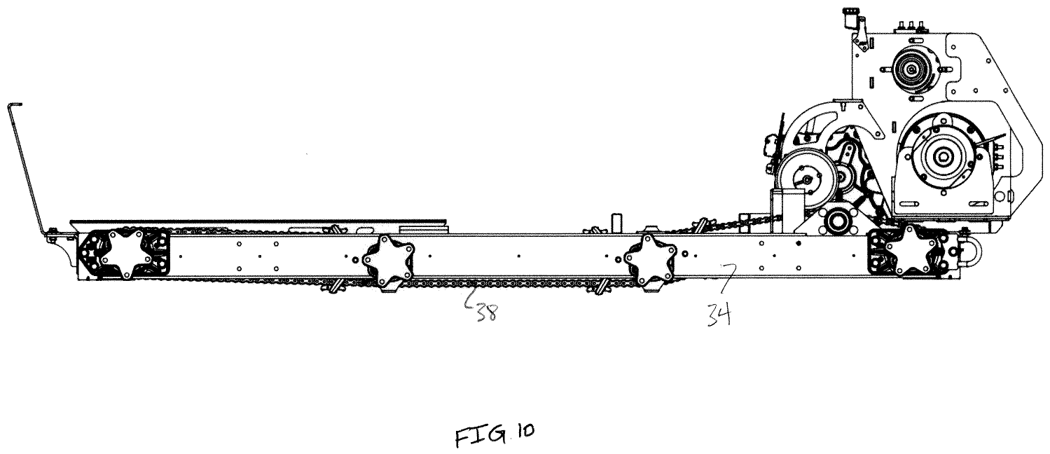

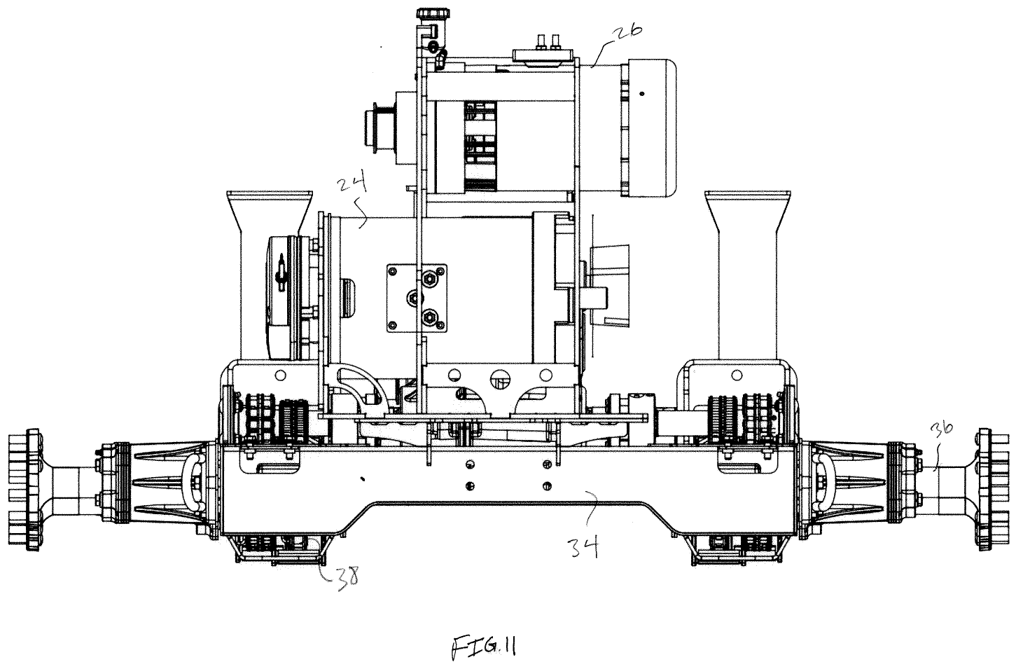

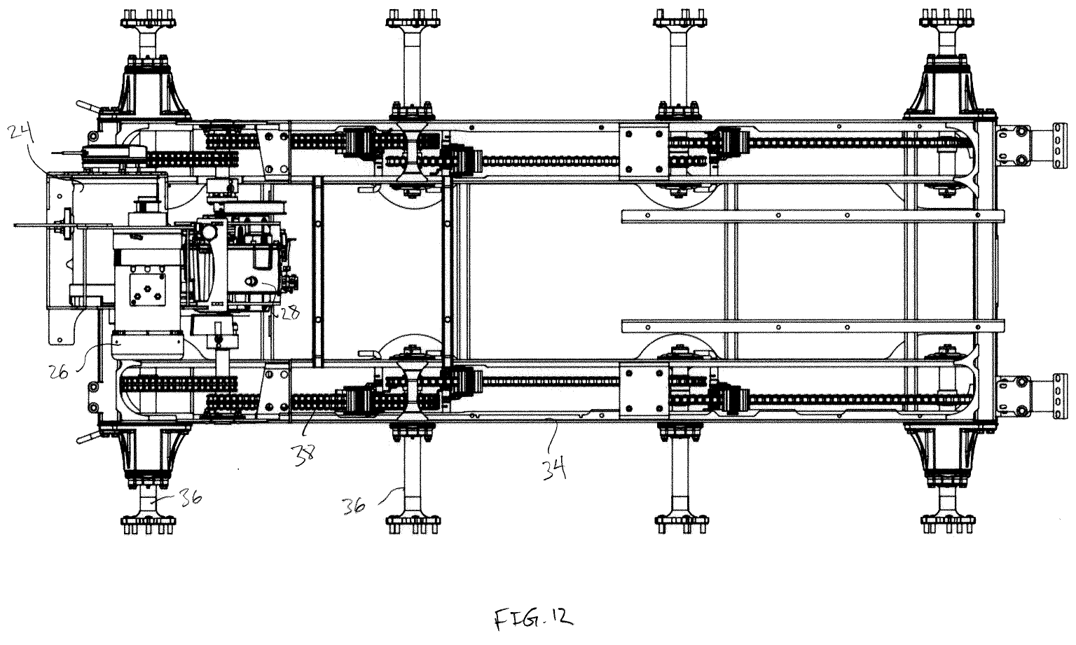

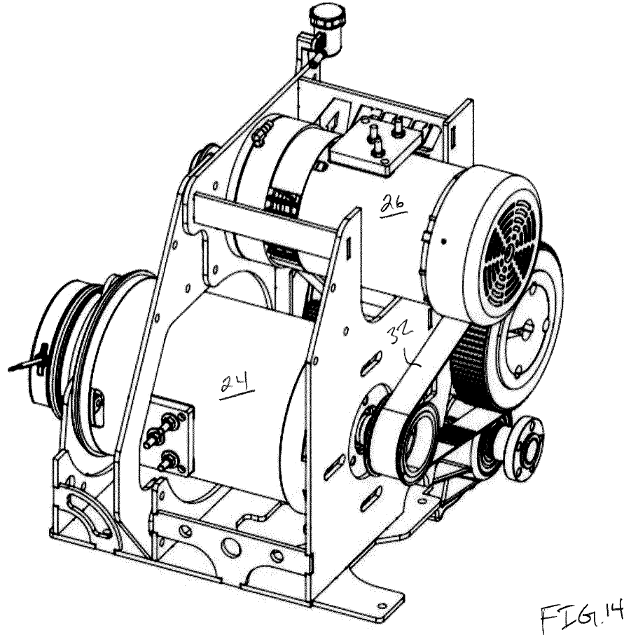

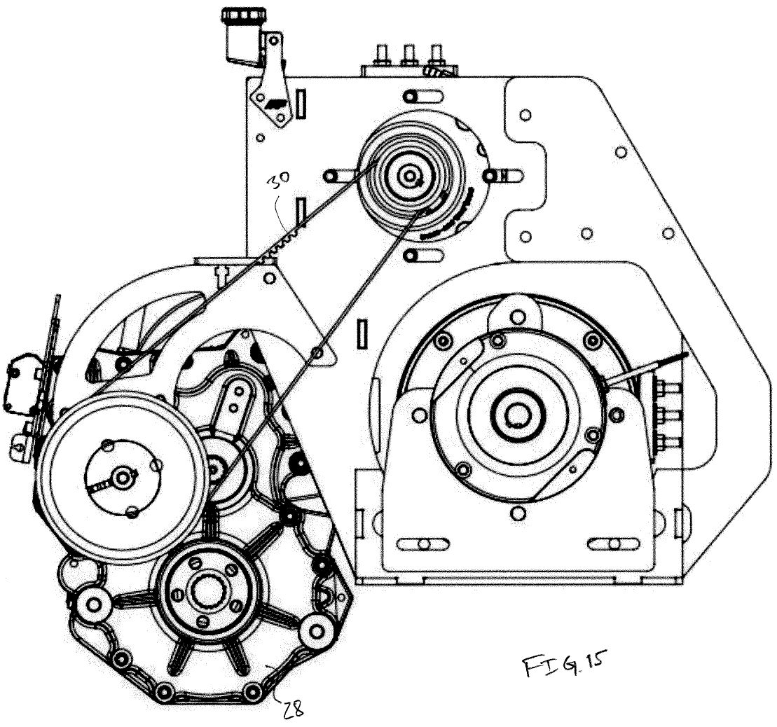

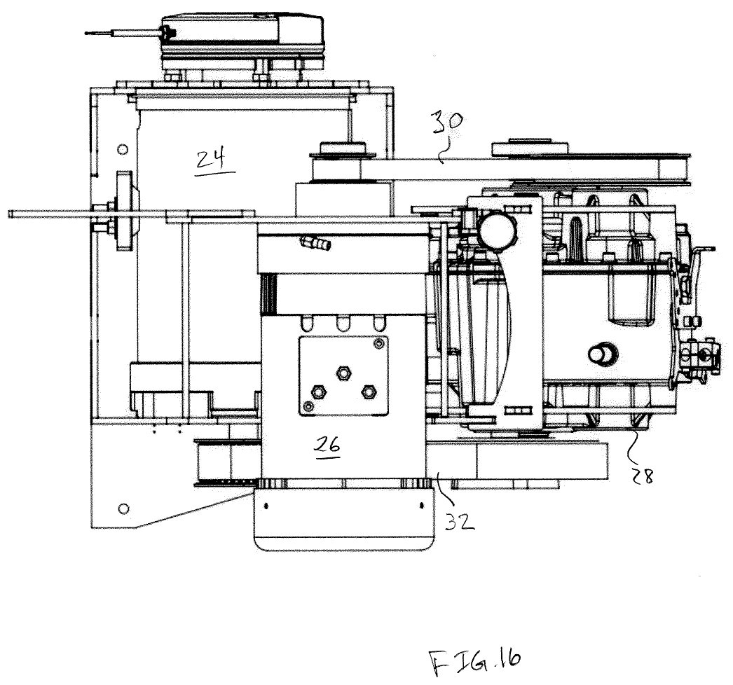

Turning to FIGS. 8-16, in some embodiments, the vehicle 10 includes an electric drive motor 24, and an electric steer motor 26. The electric drive motor 24 and electric steer motor 26 are operatively coupled to a transmission 28. The drive motor 24 may also be referred to as the traction motor. In some embodiments, the electric drive motor 24 is operatively coupled to the transmission 28 via a drive belt 32 (FIGS. 14 and 16), for example a toothed belt. In some embodiments, the electric steer motor 26 is operatively coupled to the transmission 28 via a steer belt 30 (FIGS. 15 and 16), for example a toothed belt. The transmission 28 may be of a suitable type, however, in some embodiments the transmission is of the type(s) shown in U.S. Pat. No. 11,358,636, issued Jun. 14, 2022, having title, “VEHICLE DRIVE TRANSMISSION AND ELECTRICALLY ASSISTED STEERING SYSTEM,” and assignee Ontario Drive & Gear Limited, the contents of which are herein incorporated by reference.

With further reference to FIGS. 8-12, in some embodiments, the vehicle 10 includes a chassis 34 and one or more drive axles 36. In some embodiments, the drive axles 36 are drivingly coupled to one another and to an output from the transmission 28 via one or more drive chains 38 and sprockets 39. The chassis 34 is disposed within the tub 3 (FIG. 1), while, in some embodiments, at least a portion of one or more of the drive axles 36 extends through an opening in the tub 3 so as to be attached to respective wheels, which are, in turn, coupled to the ground engaging members 14. In some embodiments, the transmission 28 has an output on each side thereof.

In some embodiments, power is supplied to the electric drive motor 24 and electric steer motor 26 by one or more batteries or battery banks. In some embodiments, the batteries are located rearwardly of the transmission 28, for example below one or more of the passenger seats 12.

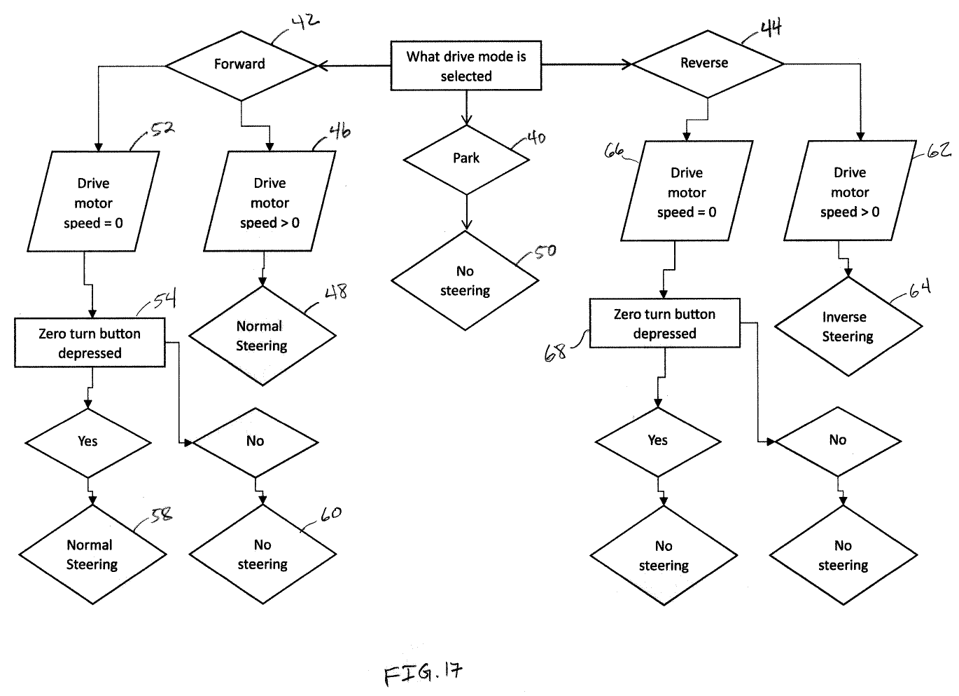

Referring to FIG. 17, the vehicle 10 includes one or more modes, for example: a park mode 40, forward mode 42, and reverse mode 44. An operator can select the desired mode, for example via a selector which can be located on the dash or steering controls of the vehicle 10. In some embodiments, the transmission 28 does not have a shiftable reverse range. Instead, the electric drive motor 24 rotates in a direction opposite that of the direction utilized when the forward mode 42 is selected.

With additional reference to FIG. 17, when the park mode 40 is selected, the steering is disabled 50—no signal is sent to the steer motor 26 to provide a steering input into the transmission 28. Further, when the park mode 40 is selected, no signal is sent to the drive motor 24 to provide a driving input into the transmission 28.

When the forward mode 42 is selected, if the drive (traction) motor speed is greater than zero RPM (shown via reference 46 in FIG. 17), the vehicle 10 exhibits normal steering 48 characteristics—turning the operator controls 16 to the left, for example, yields a left hand turn where the ground engaging members 14 on the right side of the vehicle 10 are rotating more quickly than the ground engaging members 14 on the left side of the vehicle 10.

When the speed of the drive (traction) motor 24 is zero RPM, shown at reference 52, and the zero turn selector 54 is engaged, the vehicle will exhibit normal zero turn steering characteristics—the right ground engaging members will rotate in one direction while the left ground engaging members will in the opposite direction. In some embodiments, the zero turn selector 54 is a button that can be depressed when the operator wishes to conduct a zero turn. The zero turn selector 54 is located on the steering controls 18, for example by the operator's right or left hand or in any other suitable arrangement. When the zero turn selector 54 is triggered (e.g., depressed), the forward mode 42 is selected, and the drive motor 24 is at zero RPM, the vehicle 10 will exhibit normal steering (reference 58) and a zero turn will be initiated—only the steer motor 26 will provide an input into the transmission 28 and the drive motor 24 will not provide an input into the transmission 28. If the zero turn selector 54 is not triggered (e.g., depressed), the vehicle 10 will not initiate a turn (reference 60) and the steer motor 26 will not provide an input to the transmission 28.

When the operator selects the reverse mode 44, if the speed of the drive motor 24 is zero RPM, steering for the vehicle 10 will be disabled—the steer motor 26 will not provide any input into the transmission 28. This is the case regardless of whether the zero turn selector 54 is engaged or disengaged.

When the operator selects the reverse mode 44 and the speed of the drive motor 24 is greater than zero RPM 62, however, the vehicle 10 will exhibit inverse steering characteristics 64 when backing up the vehicle 10. In reverse, “inverse steering characteristics” means that the vehicle 10 will back up to the left when the steering controls 18 are turned to the left and back up to the right when the steering controls 18 are turned to the right. In the absence of the controller programming to invert the steering by directing the steer motor 26 to operate in an inverted configuration, when the vehicle 10 is in reverse mode 44, turning the vehicle 10 to the left would result in backing up to the right and vice-versa. Therefore, the steer motor 26 is run in an inverted configuration when the vehicle 10 is in the reverse mode 44.

If the drive motor 24 is zero RPM (reference 66) and the operator selects reverse mode 44, as shown, no steering is enabled, regardless of whether the zero turn selector is selected (reference 68).

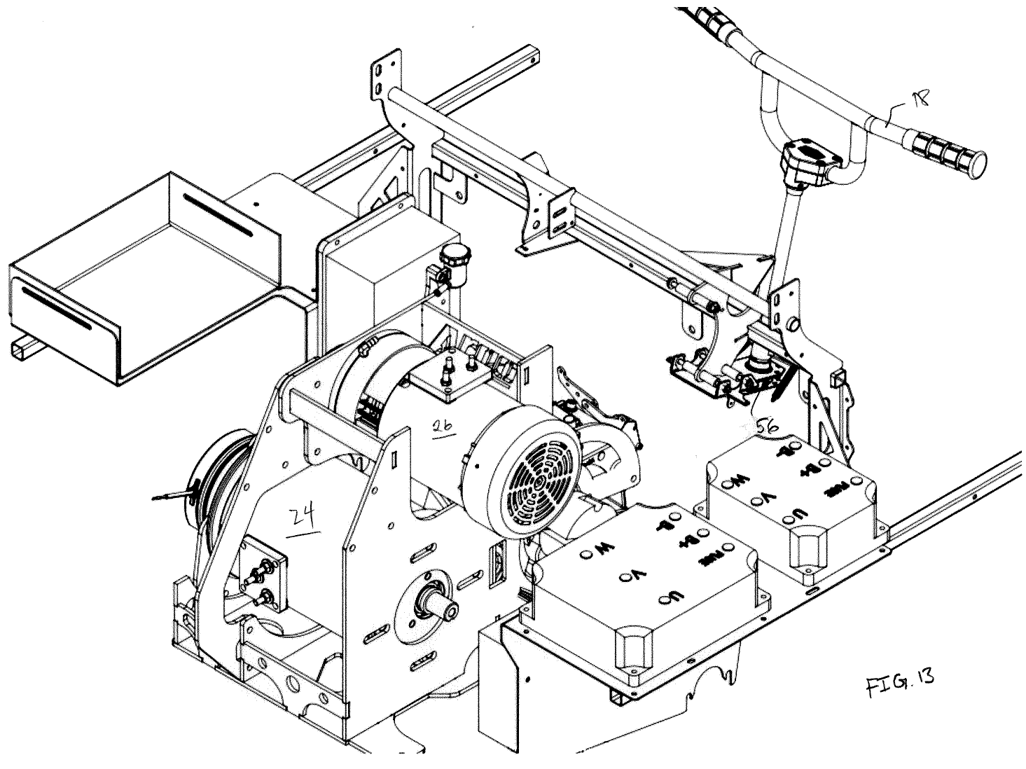

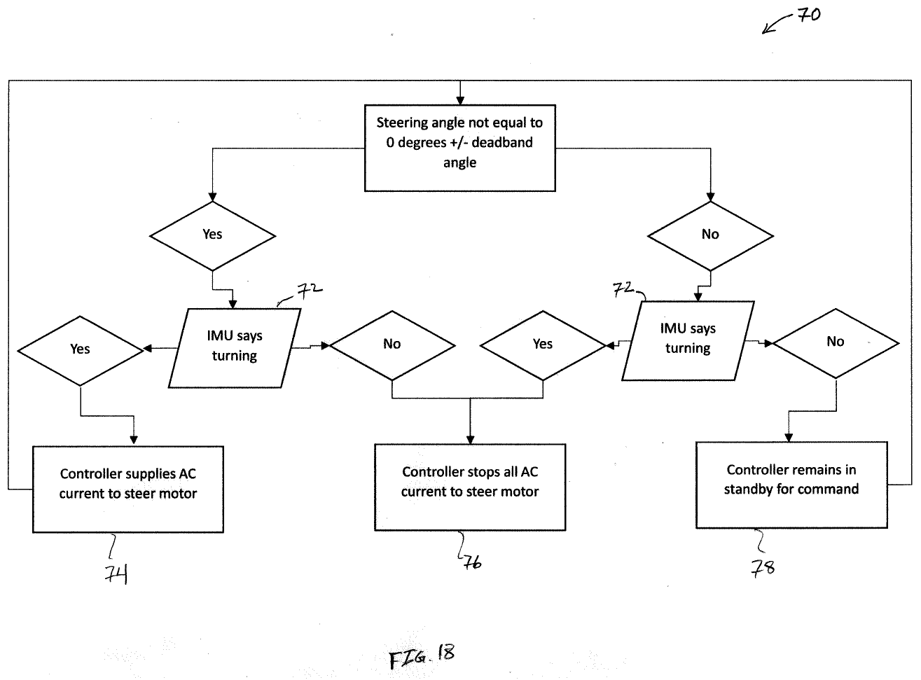

Turning to FIG. 18, in some embodiments, the vehicle 10 utilizes a safety protocol 70 to ensure that the vehicle 10 is properly responding to steering input commands from the operator. In some embodiments, a steering angle sensor 56 (FIG. 13), such as a potentiometer, senses the angle or rotation of the steering controls 18. The vehicle 10 also includes an IMU 72 (inertial measurement unit). A comparison is made between the steering angle sensor 56 and an output from the IMU in order to determine how to power the steer motor 26 (provide an input from the steer motor 26 into the transmission 28). In particular, as shown in FIG. 18, the output from the IMU needs to match the output from the steering angle sensor 56 in order or the controller (e.g., CAN bus) will turn off current to the steer motor 26. If the IMU 72 and the steering angle sensor 56 agree that a turn should be undertaken, then the controller supplies power to the steer motor (reference 74). If there is disagreement between the IMU, no power is supplied to the steer motor (reference 76). If the steering angle sensor 56 does not detect an operator input and the IMU agrees, the controller remains in standby (reference 78).

In some embodiments, the logic shown in FIGS. 17 and 18 is managed by a CAN bus (Controller Area Network) or other suitable control strategy.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

This completes the description of the preferred and alternate embodiments. Those skilled in the art may recognize other equivalents to the specific embodiment(s) described herein which equivalents are intended to be encompassed by the claims attached hereto.

1. A skid-steered vehicle comprising:
a tub;
a plurality of ground engaging members;
an electric drive motor;
an electric steer motor;
a controller;
a transmission, the transmission having a first input and a second input, the first input rotationally coupled to the electric drive motor and the second input rotationally coupled to the electric steer motor; and
a zero turn selector, the zero turn selector having a first configuration and a second configuration;
at least three operation modes, including: a park mode, a forward mode, and a reverse mode, wherein, when the vehicle is in the forward mode and the zero turn selector is in the first configuration, the controller permits the vehicle to conduct a zero turn and when the vehicle is in the forward mode and the zero turn selector is in the second configuration, the controller does not permit the vehicle to conduct a zero turn.

2. The vehicle of claim 1, wherein when the vehicle is in the park mode or reverse mode, the controller does not permit the vehicle to conduct a zero turn.

3. The vehicle of claim 1, further comprising at least six ground engaging members.

4. The vehicle of claim 1, wherein the electric drive motor is an alternating current motor.

5. The vehicle of claim 1, wherein the electric steer motor is an alternating current motor.

6. The vehicle of claim 1, wherein when the vehicle is in the reverse mode and the electric drive motor is rotating at more than zero RPM, the steer motor control is inverted.

7. The vehicle of claim 1, wherein in reverse mode, the electric drive motor rotates in a direction opposite than when the vehicle is in forward mode.

8. The vehicle of claim 1, further comprising a plurality of sprockets and chains.

9. The vehicle of claim 8, further comprising a plurality of drive axles.

10. The vehicle of claim 9, wherein at least one of the plurality of sprockets is rotationally coupled to at least one of the drive axles and wherein at least one of the chains is drivingly coupled to at least one of sprockets.

11. A skid-steered vehicle comprising:
a tub;
a plurality of ground engaging members;
an electric drive motor;
an electric steer motor;
a controller;
a transmission, the transmission having a first input and a second input, the first input rotationally coupled to the electric drive motor and the second input rotationally coupled to the electric steer motor;
steering controls;
a steering angle sensor; and
an inertial measurement unit (IMU);
wherein, the controller determines if the IMU and steering angle sensor are in agreement that the vehicle is turning and, if the IMU and steering angle sensor are not in agreement, the controller turns off current to the electric steer motor.

12. The vehicle of claim 11, wherein, if the IMU and steering angle sensor are in agreement that the vehicle is not turning, the controller remains in standby.

13. The vehicle of claim 12, wherein the electric drive motor is an alternating current motor.

14. The vehicle of claim 13, wherein the electric steer motor is an alternating current motor.

15. The vehicle of claim 14, wherein at least one of the electric drive motor and electric steer motor are coupled to the transmission via a belt.

16. The vehicle of claim 14, wherein the electric drive motor is coupled to the transmission via a belt and the electric steer motor is coupled to the transmission via a belt.
